(19) United States
(12) Patent Application Publication
(10) Pub. No.: US 2017/0106515 A1
(43) Pub. Date: Apr. 20, 2017

(54) METHOD FOR OPERATING A HAND-HELD OR SEMI-STATIONARY SETTING DEVICE

(71) Applicant: Hilti Aktiengesellschaft, Schaan (LI)

(72) Inventors: Markus Sprenger, Mauren (LI); Peter Bruggmueller, Feldkirch (AT); Julian Keller, Mauren (LI)

(73) Assignee: Hilti Aktiengesellschaft, Schaan (LI)

(21) Appl. No.: 15/128,483

(22) PCT Filed: Mar. 31, 2015
(86) PCT No.: PCT/EP2015/057020

§ 371 Date: Sep. 23, 2016

(30) Foreign Application Priority Data
Apr. 9, 2014 (EP) 14163966.6

(51) Int. Cl. B25C 1/08

(52) U.S. Cl. CPC B25C 1/08

(57) ABSTRACT

The invention relates to a hand-held or semi-stationary setting device for driving fastening elements into a substrate with the aid of a power piston, said device comprising an attachment device at one discharge end. In order to simplify the operation of a hand-held or semi-stationary setting device, waste gas leaving a combustion chamber is used during a setting operation to pre-stress the attachment device against the substrate.

### TECHNICAL FIELD

The invention relates to a method for operating a hand-held or semi-stationary setting device for driving in fastening elements into a substrate with the aid of a working piston, said device comprising an attachment device at one discharge end. The invention also relates to such a hand-held or semi-stationary setting device.

### PRIOR ART

The invention relates to a method for operating a hand-held or semi-stationary setting device for driving in fastening elements into a substrate with the aid of a working piston, said device comprising an attachment device at one discharge end. The invention also relates to such a hand-held or semi-stationary setting device.

### SUMMARY OF THE INVENTION

The object of the invention is to simplify the operation of a hand-held or semi-stationary setting device for driving fastening elements into a substrate with the aid of a working piston, said device comprising an attachment device at one discharge end.

In a method for operating a hand-held or semi-stationary setting device for driving in fastening elements into a substrate with the aid of a working piston, said device comprising an attachment device at one discharge end, this object is achieved in that in a setting operation exhaust gas coming from a combustion chamber is used in order to bias the attachment device against the substrate. The working piston is accelerated, for example by gas expanding in the combustion chamber, over a defined distance in order to drive a fastening element into the substrate. In conventional setting devices, after the working piston has travelled over the defined distance, the exhaust gas still contained in the combustion chamber, to which a residual pressure is applied, is discharged into the environment. According to a significant aspect of the invention the exhaust gas coming out of the combustion chamber is used in order to bias the attachment device against the substrate.

A preferred exemplary embodiment of the method is characterized in that the combustion chamber is connected to an additional chamber as soon as the working piston has travelled over an acceleration path. The defined distance over which the working piston is accelerated in order to drive in a fastening element is also designated as an acceleration path. When the working piston has travelled over the acceleration path, the accelerated working piston moves onwards until the setting operation is concluded. When the setting operation is concluded, the working piston is decelerated, for example with the aid of a suitable buffer device.

In a method for operating a hand-held or semi-stationary setting device for driving in fastening elements into a substrate with the aid of a working piston, said device comprising an attachment device at one discharge end, wherein the setting device is operated according to a previously described method, the object set out above is alternatively or additionally achieved in that the additional chamber has an overflow opening which is exposed by the working piston at the end of the acceleration path. The hand-held or semi-stationary setting device is operated, for example, with combustion gas. The energy required for driving in the fastening element is transferred to the fastening element by means of the working piston. In contrast to conventional solutions, such as are known for example from the German unexamined patent application DE 28 50 273 A1, only exhaust gas coming out of the combustion chamber is used in order to bias the attachment device against the substrate. This has the advantage that when the working piston is travelling the acceleration path, that is to say it is accelerating, no energy has to be taken from the combustion chamber for the attachment device.

A further preferred exemplary embodiment of the method is characterized in that the additional chamber is delimited by a surface which can be supplied with pressure and is coupled to the attachment device. The aforementioned surface is supplied via the overflow opening with the residual pressure of the exhaust gas still contained in the combustion chamber after the acceleration of the working piston.

A further preferred exemplary embodiment of the method is characterized in that the surface which can be supplied with pressure is formed on an additional piston which is coupled to the attachment device. By means of the additional piston a pressing force acting on the surface from the residual pressure of the exhaust gas can be transmitted to the attachment device in a simple manner.

A further preferred exemplary embodiment of the method is characterized in that the additional piston is designed as an annular piston. The annular piston is preferably guided movably to and fro coaxially with respect to the working piston, but independently thereof

A further preferred exemplary embodiment of the method is characterized in that the additional piston is coupled to the attachment device by means of an elastic intermediate element. The elastic intermediate element comprises, for example, a spring device, by means of which the progression of the force transmitted by the additional piston to the spring device can be adapted. As a result it is, for example, possible for the pretensioning force of the attachment device to be metered and/or delayed over time.

A further preferred exemplary embodiment of the method is characterized in that the elastic intermediate element is designed and arranged so that a maximum pretensioning force is applied to the attachment device when a driving operation begins. Suitable co-ordination with the overflow opening and the surface of the additional piston to which pressure is applied also gives rise, inter alia, to the possibility of the pretensioning force or pressing force of the attachment device being adjustable, wherein for example only a portion of the exhaust gas from the combustion zone is used. An unused portion of the exhaust gas may then be discharged into the environment, as in the case of conventional setting devices. The portion of the exhaust gas which is not required can be discharged, for example, via an additional valve device in a controlled manner.

A further preferred exemplary embodiment of the method is characterized in that the additional chamber is designed as an annular chamber. The annular space is preferably arranged radially outside a piston guide, in which the working piston is guided movably to and fro.

Furthermore, the invention relates to an attachment device for a previously described hand-held or semi-stationary setting device. The attachment device with the additional piston and possibly with the elastic intermediate element is separately available.

The setting device according to the invention is preferably a setting device for setting fastening elements, such as bolts. Therefore such a setting device is also designated as a bolt setting device. The setting device is, for example, operated with gas as fuel. The fuel tank is, for example, provided in a gas canister or gas cartridge which is inserted into the setting device.

Further advantages, features and details of the invention are apparent from the following description in which various embodiments of the invention are described in detail with reference to the drawings.

### EXEMPLARY EMBODIMENTS

In the single appended drawing a setting device according to the invention is illustrated in simplified form in longitudinal section.

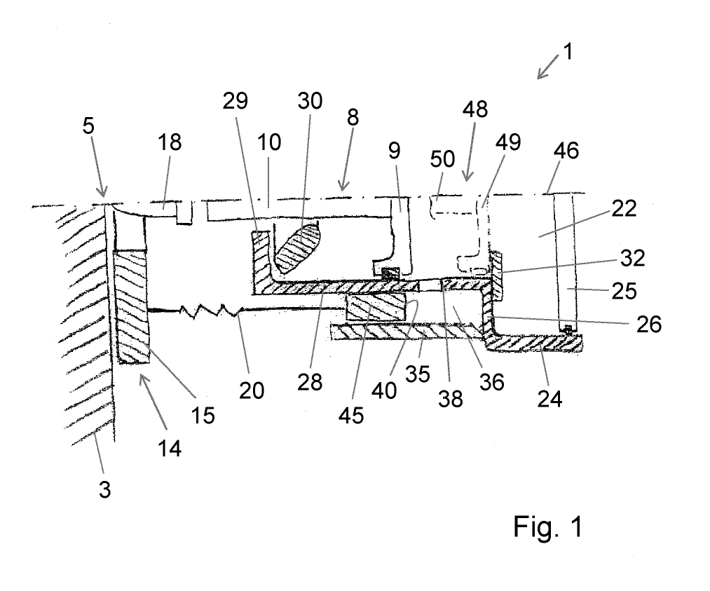

In the appended FIG. 1 a setting device 1 with a housing is illustrated in highly simplified form in longitudinal section. The setting device 1 comprises a housing, not designated in greater detail, having a handle on which the setting device 1 for driving a fastening element 18 into a substrate 3 can be mounted. The fastening element 18 projects out of the setting device 1 at a setting end or discharge end 5.

The fastening elements 18 used are preferably provided by means of a magazine which is located inside the device and is mounted in the vicinity of the discharge end or setting end 5 of the setting device 1. The fastening elements 18 are automatically withdrawn, preferably individually, from the magazine and are provided at the setting end 5.

The energy required for driving the fastening elements 18 in the substrate 3 is provided, for example, in a fuel tank 8 in the interior of the setting device 1. The fuel in the fuel tank is, for example, a liquid gas. Therefore the fuel tank is also designated as a gas canister or gas cartridge.

The fuel tank can be connected by means of an adjustable or regulable metering device to a combustion chamber 22 which is also designated as a combustion zone. The metering device is preferably designed as a metering valve.

In the combustion zone or the combustion chamber 22, fuel, that is to say gas, from the fuel tank is mixed with air to produce a combustible mixture which is ignited by an ignition device in order to drive a fastening element 18, such as a bolt or a nail, into the substrate 3. When a trigger of the setting device 1 is actuated by means of a working piston 8, the energy required for driving in is transmitted from the ignited mixture in the combustion chamber to the fastening element 18 at the setting end 5.

The working piston 8 comprises a main body 9, from which a ram 10 extends. Furthermore, the setting device 1 comprises an attachment device 14 which is placed onto the substrate 3 before a fastening element 18 is driven in. The attachment device 14 comprises an attachment plate 15 which is applied to the substrate 3.

The attachment plate 15 can be designed integrally with a guide body for the fastening element 18. The guide body can, for example, be designed as a guide sleeve which is connected integrally to the attachment plate 15. The working piston 8 is accelerated by the ignited mixture in the combustion zone 22. The path travelled by the working piston 8 during acceleration is also designated as an acceleration path.

For driving in of the fastening element 18 into the substrate 3 the working piston 8 with the ram 10 is moved further towards the substrate 3, until it has travelled over a setting path required for secure setting of the fastening element 18. After travelling over the setting path the working piston 8 with the main body 9 comes to bear against a buffer device 30 and is decelerated.

During setting of fastening elements, such as nails or bolts, with conventional setting devices on concrete, chipping frequently occurs because of the nature of the substrate 3. This chipping can reduce the retaining force of the fastening element 18 in the substrate 3. Moreover, the visual appearance of the retaining points on the otherwise relatively smooth substrate surface, for example a concrete surface, is negatively influenced and lowers the confidence in the fastening point.

The extent and frequency of this undesirable chipping can be reduced by the attachment device 14. According to a significant feature of the invention, the energy required in order to bias or to press the attachment device 14 against the substrate 3 is provided by means of exhaust gas which is supplied with a residual pressure and is still contained in the combustion chamber 22 after the working piston 8 has travelled over the acceleration path. This exhaust gas contains a relatively high proportion of energy, which can be used completely or partially in order to press the attachment device 14 against the substrate 3.

The combustion chamber 22 is delimited in the radial direction by a combustion chamber wall 24 which is substantially in the form of a circular cylinder. In the axial direction the combustion chamber 22 is delimited at its end facing away from the working piston 8 by a combustion chamber cover 25.

The combustion chamber wall 24 is integrally connected to a piston guide body 28 by means of a diameter step 26. The piston guide body 28 is likewise configured as a circular cylindrical shell, but has a smaller diameter than the combustion chamber wall 24. The piston guide body 28 forms, on its end facing the substrate 3, a stop 29 which is associated with the buffer device 30.

The stop 29 with the buffer device 30 delimits the movement of the working piston 8 in the direction of the setting end 5. In the opposite direction the path of the working piston 8 is delimited by a stop element 32 which is attached to the piston guide body 28 in the region of the diameter step 26.

The working piston 48 abutting the stop element 32, with the main body 49 and the ram 50, is indicated by broken lines in the appended drawing. The representation of the working piston 48 by a broken line corresponds to its rest position, for example before the initiation of a driving operation.

An additional wall 35 is arranged radially outside the piston guide body 28. The additional wall 35 has substantially the configuration of a circular cylindrical shell which is arranged coaxially with respect to the piston guide body 28. The additional wall 35, with the piston guide body 28 and the diameter step 26, delimits an additional chamber 36 designed as an annular chamber.

The additional chamber 36 can be connected by means of an overflow opening 38 to the combustion chamber 22. The connection between the additional chamber 36 and the combustion chamber 22 by the overflow opening 38 is regulated in a simple manner like a valve by the working piston 48.

Furthermore, the additional chamber 36 is delimited by a surface 40 which is formed on an additional piston 45. The additional piston 45 is designed as an annular piston and is movable to and fro in the additional chamber 36 which is designed as an annular chamber. The expression “movable to and fro” relates to a longitudinal axis 46, indicated by dash-dot lines, of the setting device 1.

The additional piston 45 is coupled to the attachment device 14 by means of the elastic intermediate element 20. During operation of the setting device 1, the additional piston 45 can be supplied via the overflow opening 38 with the residual pressure from the combustion chamber 22 as soon as the working piston 8 with its main body 9 has moved past the overflow opening 38 in the direction of the setting end 5. In this case the working piston 8 functions as a slide valve.

During operation of the setting device 1 combustion takes place in the combustion chamber 22. The gas pressure occurring during combustion accelerates the working piston 48. After a certain relative displacement the working body 8 with the main body 9 travels over the overflow opening 38 and a portion of the exhaust gas to which a residual pressure is then applied flows into the additional chamber 36. The residual gas pressure accelerates the additional piston 45 there. The acceleration of the additional piston 45 is transmitted to the attachment plate of the attachment device 14 by means of the elastic intermediate element 20.

1. A method for operating a hand-held or semi-stationary setting device for driving fastening elements into a substrate, the setting device comprising a working piston, a combustion chamber, and an attachment device at one discharge end, the method comprising using exhaust gas coming from the combustion chamber to bias the attachment device against the substrate.

2. The method according to claim 1, wherein the combustion chamber is connected to an additional chamber as soon as the working piston has travelled over an acceleration path.

3. A hand-held or semi-stationary setting device for driving fastening elements into a substrate according to claim 2, the setting device comprising a working piston, a combustion chamber, an additional chamber, and an attachment device at one discharge end, wherein the additional chamber an overflow opening which is exposed by the working piston at the end of an acceleration path of the working piston.

4. The hand-held or semi-stationary setting device according to claim 3, wherein the additional chamber is delimited by a surface which can be supplied with pressure and is coupled to the attachment device.

5. The hand-held or semi-stationary setting device according to claim 4, wherein the surface which can be supplied with pressure is formed on an additional piston which is coupled to the attachment device.

6. The hand-held or semi-stationary setting device according to claim 5, wherein the additional piston is an annular piston.

7. The hand-held or semi-stationary setting device according to claim 5, wherein the working piston is coupled by an elastic intermediate device to the attachment device.

8. The hand-held or semi-stationary setting device according to claim 7, wherein the elastic intermediate element is designed and arranged so that a maximum pretensioning force is applied to the attachment device when a driving operation begins.

9. The hand-held or semi-stationary setting device according to claim 3, wherein the additional chamber is an annular chamber.

10. An attachment device for a hand-held or semi-stationary setting device according to claim 3.

11. The hand-held or semi-stationary setting device according to claim 6, wherein the working piston is coupled by an elastic intermediate device to the attachment device.

12. The hand-held or semi-stationary setting device according to claim 4, wherein the additional chamber is an annular chamber.

13. The hand-held or semi-stationary setting device according to claim 5, wherein the additional chamber is an annular chamber.

14. The hand-held or semi-stationary setting device according to claim 6, wherein the additional chamber is an annular chamber.

15. The hand-held or semi-stationary setting device according to claim 7, wherein the additional chamber is an annular chamber.

16. The hand-held or semi-stationary setting device according to claim 8, wherein the additional chamber is an annular chamber.

17. The hand-held or semi-stationary setting device according to claim 11, wherein the additional chamber is an annular chamber.

18. The hand-held or semi-stationary setting device according to claim 11, wherein the elastic intermediate element is designed and arranged so that a maximum pretensioning force is applied to the attachment device when a driving operation begins.

19. The hand-held or semi-stationary setting device according to claim 18, wherein the additional chamber is an annular chamber.

20. An attachment device for a hand-held or semi-stationary setting device according to claim 4.
